(19) United States
(12) Patent Application Publication
(10) Pub. No.: US 2019/0339087 A1
(43) Pub. Date: Nov. 7, 2019

(54) DEEP REINFORCEMENT LEARNING FOR OPTIMIZING CARPOOLING POLICIES

(71) Applicant: DiDi Research America, LLC, Mountain View, CA (US)

(72) Inventors: Ishan JINDAL, Detroit, MI (US); Zhiwei QIN, San Jose, CA (US); Xuewen CHEN, Mountain View, CA (US); Matthew NOKLEBY, Detroit, MI (US); Jieping YE, Mountain View, CA (US)

(21) Appl. No.: 15/970,425

(22) Filed: May 3, 2018

(51) Int. Cl. G01C 21/34; G06N 5/04; G06F 15/18; G06F 17/17; G06Q 50/30

(52) U.S. Cl. CPC G01C 21/3453; G01C 21/3438; G06Q 50/30; G06F 15/18; G06F 17/17; G06N 5/046

(57) ABSTRACT

A method for operating a ride-share-enabled vehicle includes determining a target location of the ride-share-enabled vehicle, determining a ride-sharing policy algorithm to determine a behavior of the ride-share-enabled vehicle including whether to accept a multiple shared ride or maintain a single shared ride and a route of the multiple shared ride, if any, based on the determined target location of the ride-share-enabled vehicle, determining a behavior of the ride-share-enabled vehicle based on a current location of the ride-share-enabled vehicle and the determined ride-sharing policy algorithm, and causing the ride-share-enabled vehicle to be operated according to the determined behavior of the ride-share-enabled vehicle.

### FIELD OF THE INVENTION

This disclosure generally relates to methods and devices for operation of a ride-share-enabled vehicle.

### BACKGROUND

A vehicle dispatch platform can automatically allocate transportation requests to corresponding vehicles for providing transportation services. The transportation service can include transporting a single passenger/passenger group or carpooling multiple passengers/passenger groups. Each vehicle driver provides and is rewarded for the transportation service provided. For the vehicle drivers, it is important to maximize their rewards for their time spent on the streets.

### SUMMARY

Various embodiments of the present disclosure can include systems, methods, and non-transitory computer readable media configured for operation of a ride-share-enabled vehicle. According to one aspect, an exemplary method for operating a ride-share-enabled vehicle may comprise determining a ride-sharing policy algorithm to determine a behavior of the ride-share-enabled vehicle including whether to accept a multiple shared ride or maintain a single shared ride and a route of the multiple shared ride, if any, based on the determined target location of the ride-share-enabled vehicle, determining a behavior of the ride-share-enabled vehicle based on a current location of the ride-share-enabled vehicle and the determined ride-sharing policy algorithm, and causing the ride-share-enabled vehicle to be operated according to the determined behavior of the ride-share-enabled vehicle.

According to another aspect, the present disclosure provides a non-transitory computer-readable storage medium storing instructions that, when executed by one or more processors, cause the one or more processors to perform a method for operating a ride-share-enabled vehicle. The method may comprise the same or similar steps as the exemplary method described above.

According to another aspect, the present disclosure provides a system for providing a ride-share service including one or more ride-share-enabled vehicles and a server including one or more processors and memory storing instructions that, when executed by one or more processors, cause the one or more processors to perform a method for operating the one or more ride-share-enabled vehicles. The method may comprise the same or similar steps as the exemplary method described above.

In some embodiments, the determined ride-sharing policy algorithm may be configured based on a deep reinforced learning method of a deep Q-Networks (DQN). The exemplary method may further include determining a current date or a current time, and the ride-sharing policy algorithm may be determined also based on the current date or the current time.

The determining the ride-sharing policy algorithm may comprise determining a first ride-sharing policy algorithm as the ride-sharing policy algorithm, when the target location is a first location, and determining a second ride-sharing policy algorithm different from the first ride-sharing policy algorithm as the ride-sharing policy algorithm, when the target location is a second location different from the first location. The first location may be more populated than the second location, and the first ride-sharing policy algorithm may be configured to accept more multiple shared rides than the second ride-sharing policy algorithm. The first ride-sharing policy algorithm may not be configured based on a deep reinforced learning method of a deep Q-Networks (DQN), and the second ride-sharing policy algorithm may be configured based on the deep reinforced learning method of the DQN.

The exemplary method may further include determining a ride request density at the determined target location of the ride-share-enabled vehicle, and the ride-sharing policy algorithm may be determined based on the determined ride request density. The exemplary method may further include determining a current date or a current time, and the ride request density at the determined target location of the ride-share-enabled vehicle is determined based on the current date or the current time. The determining the ride-sharing policy algorithm may include determining a first ride-sharing policy algorithm as the ride-sharing policy algorithm, when the ride request density is a first density, and determining a second ride-sharing policy algorithm different from the first ride-sharing policy algorithm as the ride-sharing policy algorithm, when the ride request density is a second density less dense than the first location. The first ride-sharing policy algorithm may be configured to accept more multiple shared rides than the second ride-sharing policy algorithm. The first ride-sharing policy algorithm may not be configured based on a deep reinforced learning method of a deep Q-Networks (DQN), and the second ride-sharing policy algorithm may be configured based on the deep reinforced learning method of the DQN.

The target location of the ride-share-enabled vehicle may include a target service region for a ride share service. The target location of the ride-share-enabled vehicle may include the current location of the ride-share-enabled vehicle.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates an exemplary environment for providing vehicle navigation simulation environment, in accordance with various embodiments.

FIG. 2 illustrates an exemplary environment for providing vehicle navigation, in accordance with various embodiments.

FIG. 3A illustrates an exemplary reinforcement learning framework, in accordance with various embodiments.

FIGS. 3B-3E illustrate exemplary algorithms for providing vehicle navigation simulation environment, in accordance with various embodiments.

FIG. 3F illustrates an exemplary state transition for providing vehicle navigation simulation environment, in accordance with various embodiments.

FIG. 3G illustrates exemplary routing options for carpooling, in accordance with various embodiments.

FIG. 4A illustrates a flowchart of an exemplary method for providing vehicle navigation simulation environment, in accordance with various embodiments.

FIG. 4B illustrates a flowchart of an exemplary method for providing vehicle navigation, in accordance with various embodiments.

FIG. 5A illustrates exemplary geographical regions for which an experimental simulation to analyze established carpooling algorithms was performed.

FIG. 5B illustrates an experimental result of a Q-value deviation of a DQN policy and a Tabular Q policy in a less populated region from a baseline policy in (a) and (b), respectively.

FIG. 5C illustrates an experimental result of a Q-value deviation of a DQN policy and a Tabular Q policy in a more populated region from a baseline policy in (a) and (b), respectively.

FIG. 5D illustrates a table showing mean cumulative rewards on weekday and weekend on both of the less populated and more populated regions.

FIG. 6 illustrates a flowchart of an exemplary method for operation of a ride-share-enabled vehicle according to various embodiments.

FIG. 7 illustrates a block diagram of an example computer system in which any of the embodiments described herein may be implemented.

### DETAILED DESCRIPTION

Vehicle platforms may be provided for transportation services such as ride share services. Such vehicle platform may also be referred to as a vehicle hailing or vehicle dispatching platform, accessible through devices such as mobile phones installed with a platform application. Via the application, users (transportation requestors) can transmit transportation requests (e.g., a pick-up location, a destination) to the vehicle platform. The vehicle platform may relay the requests to vehicle drivers. Sometimes, two or more passengers/passenger groups may request for carpool service. The vehicle drivers can choose from the requests to accept, pick up and drop off the passengers according to the accepted requests, and be rewarded accordingly.

Existing platforms merely provide basic information of current transportation requests, by which drivers are unable to determine a best strategy (e.g., who to pick up for, whether to accept carpool) for maximizing their earnings. Or if the platform automatically matches vehicles with service requestors, the matching is only based on simple conditions such as closest in distance. Further, with current technologies, drivers are neither able to determine the best route when carpooling passengers. Therefore, to help drivers maximize their earnings and/or help passengers minimize their trip time, it is important for the vehicle platform to provide automatic decision-making functions that can revamp the vehicle service.

Various embodiments of the present disclosure include systems, methods, and non-transitory computer readable media configured to provide vehicle navigation simulation environment, as well as systems, methods, and non-transitory computer readable media configured to provide vehicle navigation. The provided vehicle navigation simulation environment may comprise a simulator for training a policy that helps maximize vehicle driver rewards and/or minimize passenger trip time. The provided vehicle navigation may be based on the trained policy to guide real vehicle drivers in real situations.

The disclosed systems and methods provide algorithms for constructing a vehicle navigation environment (also referred to as a simulator) for training an algorithm or a model based on historical data (e.g., various historical trips and rewards with respect to time and location). From the training, the algorithm or the model may provide a trained policy. The trained policy may maximize the reward to the vehicle driver, minimize the time cost to the passengers, maximize the efficiency of the vehicle platform, maximize the efficiency of the vehicle service, and/or optimize other parameters according to the training. The trained policy can be deployed on servers for the platform and/or on computing devices used by the drivers. Different policies may be applied depending on various applicable parameters, such as geographical location, population density, ride request density, time and date, and so on.

### System Architecture:

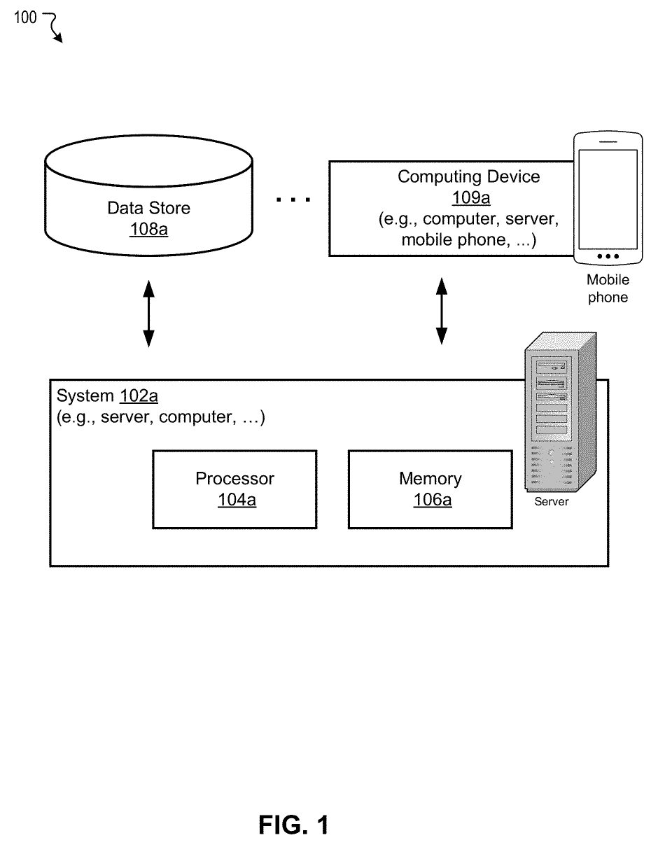

FIG. 1 illustrates an exemplary environment 100 for providing vehicle navigation simulation environment, in accordance with various embodiments. As shown in FIG. 1, the example environment 100 can comprise at least one computing system 102a that includes one or more processors 104a and memory 106a. The processor 104a may comprise a CPU (central processing unit), a GPU (graphics processing unit), and/or an alternative processor or integrated circuit. The memory 106a may be non-transitory and computer-readable. The memory 106a may store instructions that, when executed by the one or more processors 104a, cause the one or more processors 104a to perform various operations described herein. The system 102a may be implemented on or as various devices such as server, computer, etc. The system 102a may be installed with appropriate software and/or hardware (e.g., wires, wireless connections, etc.) to access other devices of the environment 100. In some embodiments, the vehicle navigation environment/simulator disclosed herein may be stored in the memory 106a as algorithms.

The environment 100 may include one or more data stores (e.g., data store 108a) and one or more computing devices (e.g., computing device 109a) that are accessible to the system 102a. In some embodiments, the system 102a may be configured to obtain data (e.g., historical trip data) from the data store 108a (e.g., database or dataset of historical transportation trips) and/or the computing device 109a (e.g., computer, server, mobile phone used by driver or passenger that captures transportation trip information such as time, location, and fees). The system 102a may use the obtained data to train an algorithm or a model for vehicle navigation. The location may comprise GPS (Global Positioning System) coordinates of a vehicle.

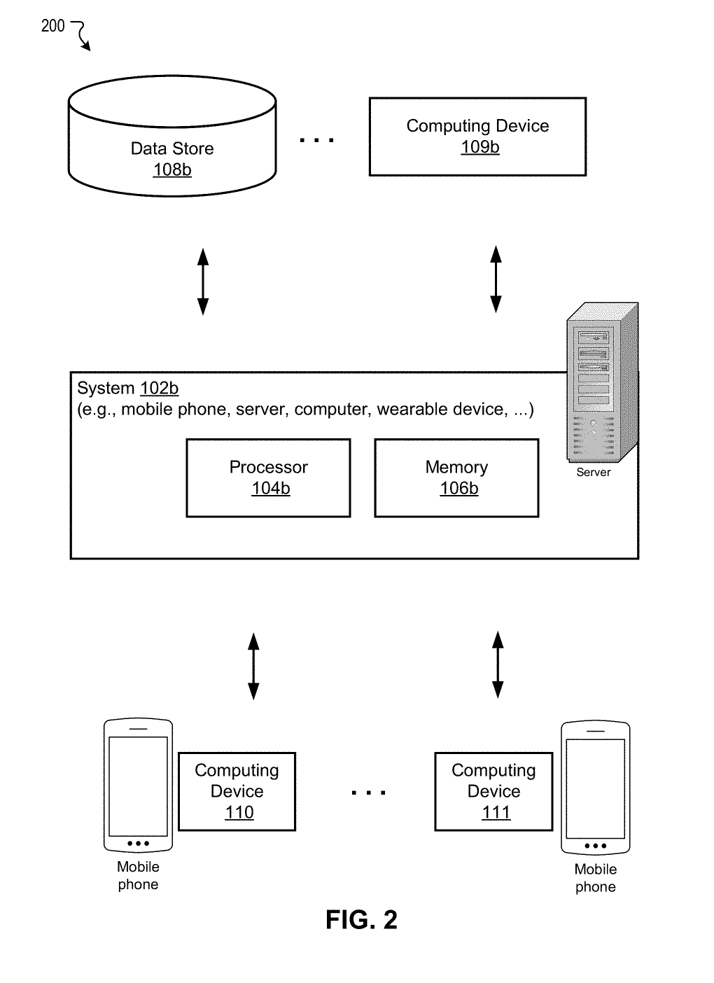

FIG. 2 illustrates an exemplary environment 200 for providing vehicle navigation, in accordance with various embodiments. FIG. 2 illustrates an exemplary environment 200 for providing vehicle navigation simulation environment, in accordance with various embodiments. As shown in FIG. 2, the example environment 200 can comprise at least one computing system 102b that includes one or more processors 104b and memory 106b. The memory 106b may be non-transitory and computer-readable. The memory 106b may store instructions that, when executed by the one or more processors 104b, cause the one or more processors 104b to perform various operations described herein. The system 102b may be implemented on or as various devices such as mobile phone, server, computer, wearable device (smart watch), etc. The system 102b may be installed with appropriate software and/or hardware (e.g., wires, wireless connections, etc.) to access other devices of the environment 200.

The systems 102a and 102b may correspond to the same system or different systems. The processors 104a and 104b may correspond to the same processor or different processors. The memories 106a and 106b may correspond to the same memory or different memories. The data stores 108a and 108b may correspond to the same data store or different data stores. The computing devices 109a and 109b may correspond to the same computing device or different computing devices.

The environment 200 may include one or more data stores (e.g., a data store 108b) and one or more computing devices (e.g., a computing device 109b) that are accessible to the system 102b. In some embodiments, the system 102b may be configured to obtain data (e.g., map, location, current time, weather, traffic, driver information, user information, vehicle information, transaction information, etc.) from the data store 108b and/or the computing device 109b. The location may comprise GPS coordinates of a vehicle.

Although shown as single components in this figure, it is appreciated that the system 102b, the data store 108b, and the computing device 109b can be implemented as single devices or multiple devices coupled together, or two or more of them can be integrated together. The system 102b may be implemented as a single system or multiple systems coupled to each other. In general, the system 102b, the computing device 109b, the data store 108b, and the computing device 110 and 111 may be able to communicate with one another through one or more wired or wireless networks (e.g., the Internet) through which data can be communicated.

In some embodiments, the system 102b may implement an online information or service platform. The service may be associated with vehicles (e.g., cars, bikes, boats, airplanes, etc.), and the platform may be referred to as a vehicle (service hailing or ride order dispatching) platform. The platform may accept requests for transportation, identify vehicles to fulfill the requests, arrange for pick-ups, and process transactions. For example, a user may use the computing device 111 (e.g., a mobile phone installed with a software application associated with the platform) to request transportation from the platform. The system 102b may receive the request and relay it to various vehicle drivers (e.g., by posting the request to mobile phones carried by the drivers). One of the vehicle drivers may use the computing device 110 (e.g., another mobile phone installed with the application associated with the platform) to accept the posted transportation request and obtain pick-up location information. Similarly, carpool requests from multiple passengers/passenger groups can be processed. Fees (e.g., transportation fees) can be transacted among the system 102b and the computing devices 110 and 111. The driver can be compensated for the transportation service provided. Some platform data may be stored in the memory 106b or retrievable from the data store 108b and/or the computing devices 109b, 110, and 111.

The environment 100 may further include one or more computing devices (e.g., computing devices 110 and 111) coupled to the system 102b. The computing devices 110 and 111 may comprise devices such as cellphone, tablet, computer, wearable device (smart watch), etc. The computing devices 110 and 111 may transmit or receive data to or from the system 102b.

Referring to FIG. 1 and FIG. 2, in various embodiments, the environment 100 may train a model to obtain an policy, and the environment 200 may implement the trained policy. For example, the system 102a may obtain data (e.g., training data) from the data store 108 and/or the computing device 109. The training data may comprise historical trips taken by passengers/passenger groups. Each historical trip may comprise information such as pick-up location, pick-up time, drop-off location, drop-off time, fee, etc. The obtained data may be stored in the memory 106a. The system 102a may train a model with the obtained data or train an algorithm with the obtained data to learn a model for vehicle navigation. In the latter example, the algorithm of learning a model without providing a state transition probability model and/or a value function model may be referred to as a model-free reinforcement learning (RL) algorithm. By simulation, the RL algorithm may be trained to provide a policy that can be implemented in real devices to help drivers make optimal decisions.

### Policy Configuration:

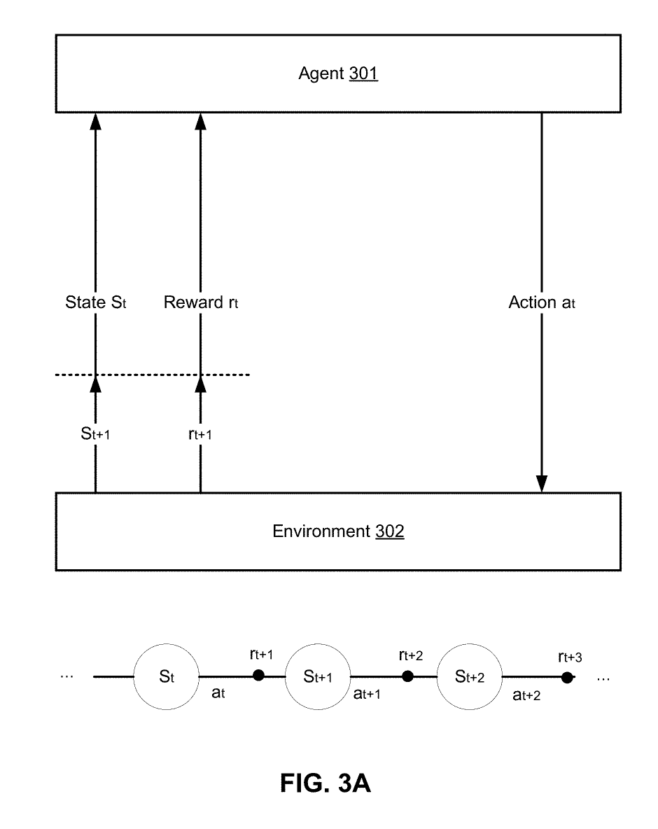

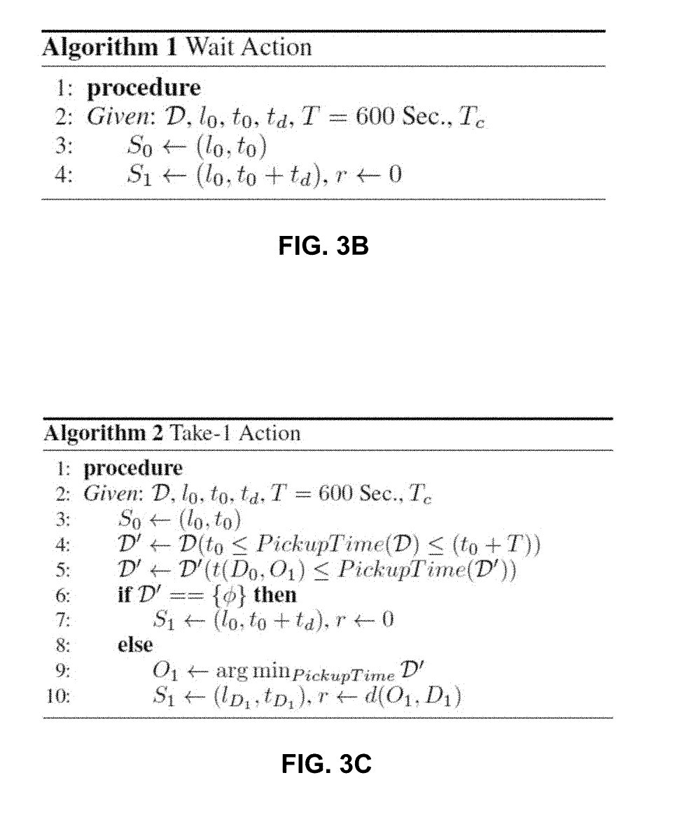

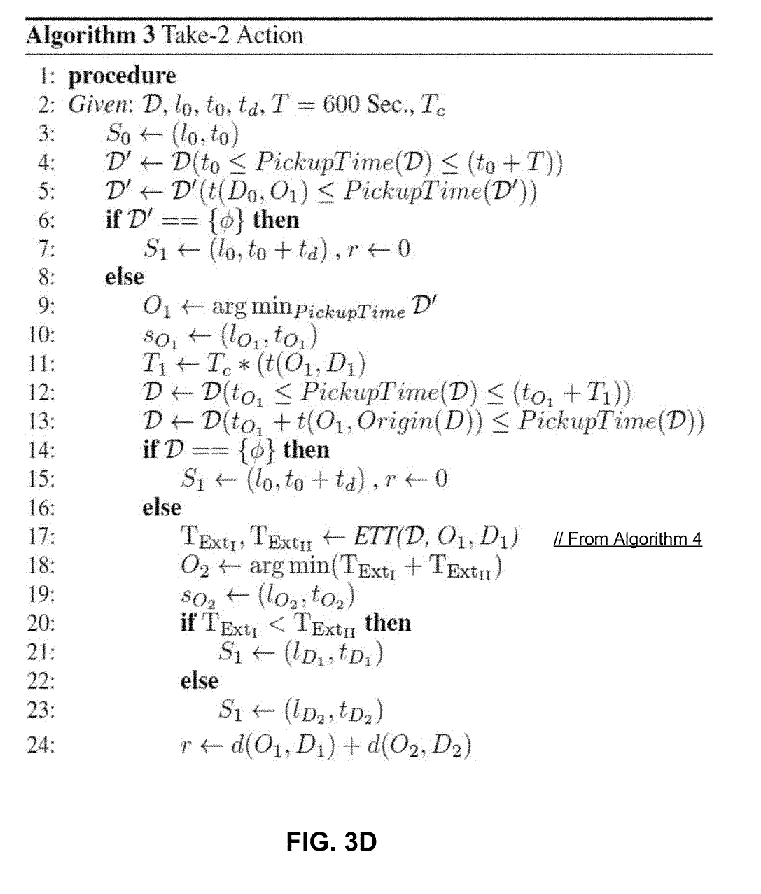

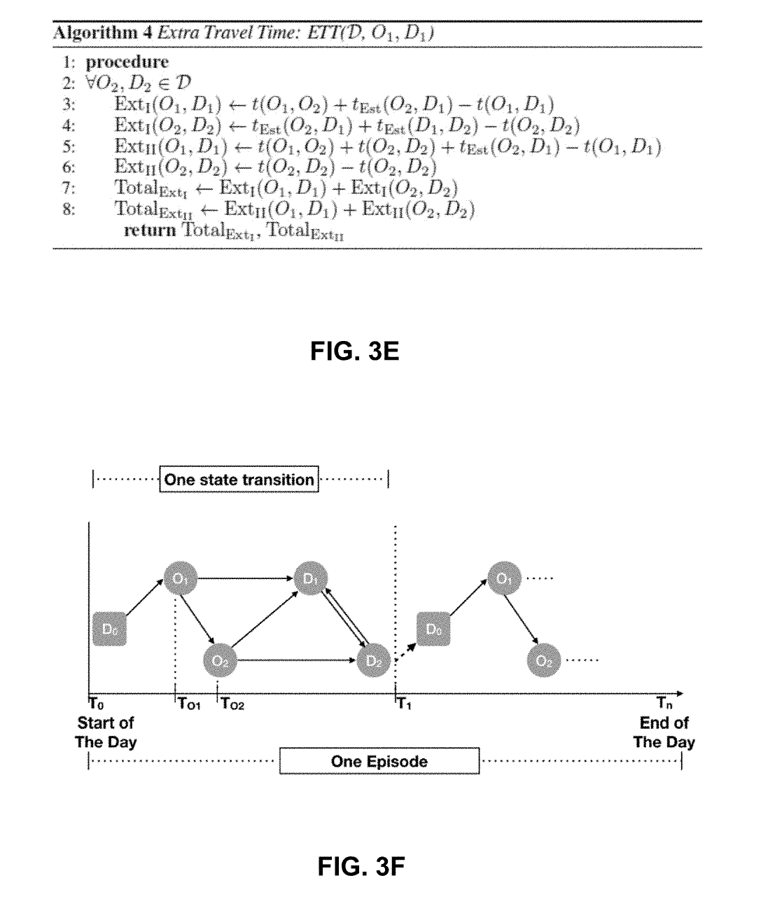

FIG. 3A illustrates an exemplary reinforcement learning framework, in accordance with various embodiments. As shown in this figure, for an exemplary RL algorithm, a software agent 301 takes actions in an “environment” 302 (or referred to as “simulator”) to maximize a “reward” for the agent. The agent and environment interact in discrete time steps. In training, at time step t, the agent observes the state of the system (e.g., state Sₜ), produces an action (e.g., action at), and gets a resulting reward (e.g., reward rₜ₊₁) and a resulting next state (e.g., state Sₜ₊₁). Correspondingly, at time step t, the environment provides one or more states (e.g., state Sₜ) to the agent, obtains the action taken by the agent (e.g., action at), advances the state (e.g., state Sₜ₊₁), and determines the reward (e.g., reward rₜ₊₁). Relating to the vehicle service context, the training may be comparable with simulating a vehicle driver's decision as to waiting at the current position, picking up one passenger group, or carpooling two passenger groups (comparable to the agent's actions), with respect to time (comparable with the states), vehicle and customer location movements (comparable with the states), earnings (comparable with the reward), etc. Each passenger group may comprise one or more passengers.

Back to the simulation, to produce an optimal policy that governs the decision-making at each step, a corresponding state-action value function of the driver may be estimated. The value function can show how good a decision made at a particular location and time of the day with respect to the long-term objective (e.g., maximize earnings). At each step, with states provided by the environment, the agent executes an action (e.g., waiting, transporting one passenger group, two passenger groups, three passenger groups, etc.), and correspondingly from the environment, the agent receives a reward and updated states. That is, the agent chooses an action from a set of available actions, and the agent moves to a new state, and the reward associated with the transition is determined for the action. The transition may be recursively performed, and the goal of the agent is to collect as much reward as possible.

For the simulation, the RL algorithm builds on a Markov decision process (MDP). The MPD may depend on observable state space S, action space a, state transition probabilities, reward function r, starting state, and/or reward discount rate, some of which are described in details below. The state transition probabilities and/or reward function r may be known or unknown (referred to as model-free methods).

State, S: the states of a simulation environment may comprise location and/or time information. For example, the location information may comprise geo-coordinates of a simulated vehicle and time (e.g., time-of-day in seconds): S=(l, t), where I is the GPS coordinates pair (latitude, longitude), and t is time. S may contain additional features that characterize the spatio-temporal space (l, t).

Action, a: the action is assignment to the driver, the assignment may include: waiting at the current location, picking up a certain passenger/passenger group, picking up multiple passengers/passenger groups and transport them in carpool, etc. The assignment with respect to transportation may be defined by pick-up location(s), pick-up time point(s), drop-off location(s), and/or drop-off time point(s).

Reward, r: the reward may comprise various forms. For example, in simulation, the reward may be represented by a nominal number determined based on a distance. For example, in a single passenger trip, the reward may be determined based on a distance between a trip's origin and destination. For another example, in a two passenger carpooling trip, the reward may be determined based on a sum of: a first distance between the first passenger's origin and destination, and a second distance between the second passenger's origin and destination. In real life, the reward may relate to a total fee for the transportation, such as the compensation received by the driver for each transportation. The platform may determine such compensation based on a distance traveled or other parameters.

Episode: the episode may comprise any time period such as one complete day from 0:00 am to 23:59 pm. Accordingly, a terminal state is a state with t component corresponding to 23:59 pm. Alternatively, other episode definitions for a time period can be used.

Policy, π: a function that maps a state to a distribution over the action space (e.g., stochastic policy) or a particular action (e.g., deterministic policy).

In various embodiments, the trained policy from RL beats existing decision-making data and other inferior policies in terms of the cumulative reward. The simulation environment can be trained with historical data of trips taken by historical passenger groups, such as a data set of historical taxi trips within a given city. The historical data can be used to bootstrap sample passenger trip requests for the simulation. For example, given one month of trips data, a possible way of generating a full day of trips for a simulation run is to sample one-fourth of the trips from each hour on the given day-of-week over the month. For another example, it can be assumed that after a driver drops off a passenger at her destination, and from the vicinity of the destination, the driver would be assigned a new trip request. According to action searches and/or route determinations described below, the action of a simulated vehicle can be selected by the given policy, which may comprise fee-generating trips, wait actions, etc. The simulation can be run for multiple episodes (e.g., days), and the cumulative reward gained can be computed and averaged over the episodes.

Detailed algorithms for providing the environment are provided below with reference to FIGS. 3B-3G. The environment can support various modes. In a Reservation Mode, transportation request(s) from passenger(s) are known to the simulated vehicle in advance, and the carpooling decision (e.g., whether to carpool multiple passengers) is made at the time when the vehicle is vacant, that is, having no passengers. In agreement to the RL terminologies, the driver's (agent's) state which may comprise a (location, time) pair, the agent's action, and the reward collected after executing each action are tracked.

In some embodiments, an exemplary method for providing vehicle navigation simulation environment may comprise recursively performing steps (1)-(4) for a time period. The steps (1)-(4) may include: step (1) providing one or more states (e.g., the state S) of a simulation environment to a simulated agent, wherein the simulated agent comprises a simulated vehicle, and the states comprise a first current time (e.g., t) and a first current location (e.g., I) of the simulated vehicle; step (2) obtaining an action by the simulated vehicle when the simulated vehicle has no passenger, wherein the action is selected from: waiting at the first current location of the simulated vehicle, and transporting M passenger groups, wherein each of the M passenger groups comprises one or more passengers, and wherein every two groups of the M passenger groups have at least one of: different pick-up locations or different drop-off locations; step (3) determining a reward (e.g., the reward r) to the simulated vehicle for the action; and step (4) updating the one or more states based on the action to obtain one or more updated states for providing to the simulated vehicle, wherein the updated states comprise a second current time and a second current location of the simulated vehicle.

In some embodiments, the “passenger group” is to distinguish passengers that are picked up from different locations and/or dropped off at different locations. If passengers share the same pick-up and drop-off locations, they may belong to the same passenger group. Each passenger group may comprise just one passenger or multiple passengers. Further, the simulated vehicle may have a capacity for N passengers, and during at any time of the transportation, the number of total passengers on board may not exceed N. When referring to the passenger herein, the driver is not counted.

In some embodiments, obtaining the action by the simulated vehicle when the simulated vehicle has no passenger comprises obtaining the action by the simulated vehicle only when the simulated vehicle has no passenger; and the simulated vehicle performs the action for the each recursion.

In some embodiments, if the action in step (2) is transporting the M passenger groups, in the step (4) the second current time is a current time corresponding to having dropped off all of the M passenger groups and the second current location is a current location of the vehicle at the second current time.

In some embodiments, in the Reservation Mode, the action of taking M passenger groups (which include waiting at the current location when M=0) and the transportation assignment(s) are assigned to the simulated vehicle in sequence. The agent can learn a policy to cover only first-level actions (e.g., determining the number M for transporting M passenger groups, which includes waiting at the current location when M=0) or both the first-level actions and second-level actions (e.g., which second passenger group to pick up after picking up a first passenger group, which route to take when carpooling multiple passenger groups, etc.). In the first case, the learned policy makes the first-level decisions, whereas the secondary decisions can be determined by Algorithms 2 and 3. In the second case, the policy bears the responsibility in determining M as well as routing and planning of the carpooling trip. The various actions are described in details below with reference to respective algorithms. For the RL training, at the start of the episode, D₀ is the initial state S₀=(l₀, t₀) of the vehicle, whereas the actual origin of a vehicle transportation trip is O₁, and S_{O1}=, t_{O1}) is the intermediate state of the vehicle when picking up the first passenger. Such representations and similar terms are used in the algorithms below.

FIG. 3B illustrates an exemplary Algorithm 1 for providing vehicle navigation simulation environment, in accordance with various embodiments. The operations shown in FIG. 3B and presented below are intended to be illustrative.

Algorithm 1 may correspond to a Wait Action (W). That is, M=0 and the simulated vehicle is assign to wait at its current location without picking up any passenger group. When the wait action is assigned to the vehicle at state S₀=(l₀, t₀), the vehicle stays at the current location l₀ while the time to advances by t_{d}. Therefore, the next state of the driver would be (l₀, t₀+t_{d}) as described in line 4 of Algorithm 1. That is, if the action at the step (2) is waiting at the current location of the simulated vehicle, the second current time is a current time corresponding to the first current time plus a time segment t_{d}, and the second current location is the same as the first current location.

FIG. 3C illustrates an exemplary Algorithm 2 for providing vehicle navigation simulation environment, in accordance with various embodiments. The operations shown in FIG. 3C and presented below are intended to be illustrative.

Algorithm 2 may correspond to a Take-1 Action (transporting 1 passenger group). That is, M=1. Given the initial state of S₀, a transportation trip is assigned to the simulated vehicle for which the vehicle can reach the origin O₁ of the transportation trip in a time less than the historical pick-up time of the passenger group. For example, referring to line 4 of Algorithm 2, a transportation request search area can be reduced by finding all historical transportation trips having pickup time in the range of t₀ to (t₀+T) irrespective of the origins of the historical trips, where T defines the search time window (e.g., 600 seconds). Referring to line 5 of Algorithm 2, the transportation trip search area can be further reduced by finding all historical vehicle trips where the simulated vehicle can reach before the historical pickup time from the simulated vehicle's initial state S₀. Here, t(D₀, O₁) can represent the time for advancing from state D₀ to state O₁. Since the historical transportation data can represent when and where transportation demands arise, filtering the transportation request search by historical pick-up time in line 4 can obtain customer candidates matching a time window for potentially being picked up, while ignoring how far or close these customer candidates are. Additionally filtering the transportation request search by proximity to the location of the vehicle in line 5 can further narrow the group of potential customers who are mostly suitable to be picked up from reward maximization. Referring to lines 6-7 of Algorithm 2, if there is no such trip origin, similar to the Algorithm 1, the simulated vehicle continues waiting at its current location l₀ but the time advance to (t₀+t_{d}) and the state of the vehicle becomes S₁=(l₀, t₀+t_{d}). And the reward for the waiting action is 0. Whereas, referring to lines 9-10 of Algorithm 2, if there exist such historical vehicle trips, a historical vehicle trip with minimum pick-up time (the least time to reach its pick-up location) is assigned to the simulated vehicle. Finally, the simulated vehicle picks up the passenger group from the origin of assigned trip and drops the passenger group at the destination, and its state is updated to S₁=(l_{D1}, t_{D1}) upon completing the state transition. Here, l_{D1} represents the drop-off location of the passenger group and t_{D1} is the time of day when the simulated vehicle reaches the destination D₁.

Thus, in some embodiments, the method for providing vehicle navigation simulation environment may further comprise, based on historical data of trips taken by historical passenger groups: searching for one or more first historical passenger groups, wherein: (condition A) time points when the first historical passenger groups were respectively picked up from first pick-up locations are within a first time threshold from the first current time, and (condition B) time points for the simulated vehicle to reach the first pick-up locations from the first current location are respectively no later than historical time points when the first passenger groups were picked up; and in response to finding no first historical passenger group satisfying the (condition A) and (condition B), assigning the simulated vehicle to wait at the first current location, and correspondingly determining the reward for the current action to be zero.

In some embodiments, if M=1 and in response to finding one or more first historical passenger groups satisfying the (condition A) and (condition B), the method may further comprise assigning the simulated vehicle to transport passenger group P associated with a first pick-up location that takes the least time to reach from the first current location, and correspondingly determining the reward for the current action based on a travel distance by the passenger group P for the assigned transportation, wherein the passenger group P is one of the found first historical passenger groups.

FIG. 3D illustrates an exemplary Algorithm 3 for providing vehicle navigation simulation environment, in accordance with various embodiments. The operations shown in FIG. 3D and presented below are intended to be illustrative.

Algorithm 3 may correspond to a Take-2 Action (transporting 2 passenger groups in carpool). That is, M=2. Referring to lines 3-7 of Algorithm 3, given the initial state S₀, a first transportation task is assigned to the simulated vehicle similar to the Take-1 action. Once the first transportation task is assigned, the simulated vehicle reaches the origin location O₁ to pick up the first passenger group and its intermediate state is updated to S_{O1}=(l_{O1}, t_{O1}).

From the intermediate state S_{O1}, how a second transportation task is assigned to the simulated vehicle is described in lines 9-24 of Algorithm 3, where a second transportation task is assigned to the driver by following a similar procedure to assigning the first transportation task, and the state of the simulated vehicle is updated to S_{O2}=(l_{O2}, t_{O2}). Referring to line 12 of Algorithm 3, the difference from the Algorithm 2 is the transportation trip's pickup time search range. For the second transportation task, the trip search area is reduced by selecting all the historical transportation trips in pickup time range of t_{O1} to (t_{O1}+(T_{c}*t(O₁, D₁))) irrespective of the origin locations of the historical transportation trips. Here, t(O₁, D₁) can represent the time for transporting the first passenger group alone from its origin to destination. The simulated vehicle may have to stay at the intermediate state S_{O1} for up to (T_{c}*t(O₁, D₁)) seconds while the search for the second transportation request is being made. Here, T_{c} is in the range of (0, 1) and is an important parameter which controls the trip search area for the second transportation task assignment.

The second transportation task search area may not be fixed. For instance, assuming the size of search time window is fixed to T=600 s similar to first transportation task. The pick-up time search range for second transportation task becomes (t_{O1}, t_{O1}+T). From the historical dataset, if a historical vehicle can complete the assigned trip for the first passenger group from O₁ to D₁ in t(O₁, D₁)=500 s<T, it is more efficient to assign Take-1 Action to the simulated vehicle rather than assigning Take-2 Action. Therefore, a dynamic pick-up time search range is needed for selecting the second transportation task. Referring to line 13 of Algorithm 3, after reducing the pick-up time search area for second transportation task, the search area can be further reduced by selecting all the historical transportation trips where simulated vehicle can reach before the historical pick-up time points toe from its intermediate state S_{O1}.

Thus, in some embodiments, the method for providing vehicle navigation simulation environment may further comprise: if M=2 and in response to finding the one or more first historical passenger groups satisfying the (condition A) and (condition B) described above, assigning the simulated vehicle to pick up passenger group P associated with a first pick-up location that takes the least time to reach from the first current location, wherein the passenger group P is one of the found first historical passenger groups; determining a time T for transporting the passenger group P from the first pick-up location to a destination of the passenger group P; searching for one or more second historical passenger groups, wherein: (condition C) time points when the second historical passenger groups were respectively picked up from second pick-up locations are within a second time threshold from time point when the passenger group P was picked up, the second time threshold being a portion of the determined time T, and (condition D) time points for the simulated vehicle to reach the second pick-up locations from the time when the passenger group P was picked up are respectively no later than historical time points when the second historical passenger groups were picked up; and in response to finding no second historical passenger group satisfying the (condition C) and (condition D), assigning the simulated vehicle to wait at the first pick-up location of the passenger group P.

Having determined the two passenger groups to transport for M=2, the simulated vehicle has picked up 1 first passenger group and determined choices for the second passenger group. (The first and second passenger groups have different destinations D₁ and D₂). Which second passenger group to choose and which of the first and second passenger groups to drop off first can be determined according to lines 17-24 of Algorithm 3. Referring to line 18 of Algorithm 3, a second passenger group corresponding to the minimum (T_{ExtI}+T_{ExtII}) can be chosen by the simulated vehicle under the current policy. T_{ExtI} and T_{ExtII} can be referred to Algorithm 4 described in FIG. 3E, which illustrates an exemplary Algorithm 4 for providing vehicle navigation simulation environment, in accordance with various embodiments.

In one example, the problems to solve here may be deterministic and this decision making can be lumped as a part of secondary decision making. Referring to FIG. 3F, FIG. 3F illustrates an exemplary state transition for providing vehicle navigation simulation environment, in accordance with various embodiments. The operations shown in FIG. 3F and presented below are intended to be illustrative. FIG. 3F shows an episode of one day within which multiple state transitions (corresponding to the recursions described above) can be performed. An exemplary state transition involving carpooling two passenger groups are provided. As described above, the simulated vehicle may start at state D₀ at T₀, moves to state O₁ at T_{O1} to pick up a first passenger group, and then moves to state O₂ at T_{O2} to pick up a second passenger group. After both passenger groups are dropped off, at T₁, the simulated vehicle may move onto a next state transition.

After the second passenger group has been picked up, the simulated vehicle has options to drop off the first or second passenger group. FIG. 3G illustrates exemplary routing options for carpooling, in accordance with various embodiments. The operations shown in FIG. 3G and presented below are intended to be illustrative. FIG. 3G shows two possible solutions to the routing problem. That is, after picking up the two passenger groups for carpool, the simulated vehicle can either follow:

D₀→O₁→O₂→D₁→D₂ shown as Path I in FIG. 3G,

or

D₀→O₁→O₂→D₂→D₁ shown as Path II in FIG. 3G.

In Path I, D₂ is the final state of the simulated vehicle for the current state transition and is also the initial state for the next state transition. In Path II, D₁ is the final state of the simulated vehicle for the current state transition and is also the initial state for the next state transition.

Referring back to lines 17-24 of Algorithm 3 and Algorithm 4, a second transportation task with the minimum sum of total extra passenger travel time can be assigned to the simulated vehicle. In some embodiments, to choose among the paths, an extra passenger travel time Ext_{P}(x, y) traveled by a vehicle going from x to y when a path P is chosen can be defined. The extra travel time Ext_{P}(. , .) is an estimation of extra time each passenger group would have spent during carpool which otherwise is zero if no carpool is taken. For instance, in FIG. 3G the actual travel time without carpool for passenger group 1 picked up from O₁ is t(O₁, D₁) and for passenger group 2 picked up from O₂ is t(O₂, D₂) respectively. However, with carpool, the travel time for passenger group 1 picked up from O₁ is t(O₁, O₂)+t_{Est}(O₂, D₁), and for passenger group 2 picked up from O₂ is t_{Est}(O₂, D₁)+t_{Est}(D₁, D₂). The estimated travel time t_{Est}(. , .) can be the output of a prediction algorithm, an example of which is discussed in the following reference incorporated herein by reference in its entirety: I. Jindal, Tony, Qin, X. Chen, M. Nokleby, and J. Ye., A Unified Neural Network Approach for Estimating Travel Time and Distance for a Taxi Trip, ArXiv e-prints, October 2017.

Referring back to FIG. 3E, Algorithm 4 shows how to obtain the extra passenger travel time for both paths. When Take-1 action is assigned, the extra passenger travel time is always zero, but here a Take-2 action is assigned. Accordingly, the extra travel time for passenger group 1, when Path I is followed, is:

Ext_{I}(O₁,D₁)=t(O₁,O₂)+t_{Est}(O₂,D₁)−t(O₁,D₁)

The extra travel time for passenger group 2, when Path I is followed, is:

Ext_{I}(O₂,D₂)=t_{Est}(O₂,D₁)+t_{Est}(D₁,D₂)−t(O₂,D₂)

The extra travel time for passenger group 1, when Path II is followed, is:

Ext_{II}(O₁,D₁)=t(O₁,O₂)+t(O₂,D₂)+t_{Est}(O₂,D₁)−t(O₁,D₁)

The extra travel time for passenger group 2, when Path II is followed, is:

Ext_{II}(O₂,D₂)=t(O₂,D₂)−t(O₂,D₂)=0

From the individual extra travel time for the on-board passenger groups for both the paths, the total extra passenger travel time can be obtained for each path. That is, for Path I, Total_{ExtI}=T_{ExtI}=Ext_{I}(O₁, D₁)+Ext_{I}(O₂, D₂). For Path II, Total_{ExtII}=T_{ExtII}=Ext_{II}(O₁, D₁)+Ext_{II}(O₂, D₂). Thus, referring to lines 20-23 of Algorithm 3, to minimize extra time cost to passengers, the simulated vehicle can choose Path I if Total_{ExtI}<Total_{ExtII} and otherwise follow Path II.

After the transition is completed (at T₁ in FIG. 3F), the environment may compute the reward for this transition. Referring to line 24 of Algorithm 3, the reward can be based on the effective trip distance fulfilled by the carpooling trip, and by the sum of the original individual trip distances d(O₁, D₁)+d(O₂, D₂). The agent is then ready to execute a new action of the action set described above. Similarly, Take-3 Action, Take-4 Action, or any Take-M action as long as consistent with the vehicle capacity can be similarly derived.

Thus, in some embodiments, the method for providing vehicle navigation simulation environment may further comprise: in response to finding the one or more second historical passenger groups satisfying the (condition C) and (condition D), assigning the simulated vehicle to transport passenger group Q, wherein: the passenger group Q is one of the found second historical passenger groups; transporting the passenger groups P and Q takes the least sum of: a total extra passenger travel time for (routing option 1) and a total extra passenger travel time for (routing option 2); the (routing option 1) comprises picking up the passenger group Q, then dropping of the passenger group P, and then dropping of the passenger group Q; the (routing option 2) comprises picking up the passenger group Q, then dropping of the passenger group Q, and then dropping of the passenger group P; the total extra passenger travel time for the (routing option 1) is a summation of extra time costing the passenger groups P and Q when transported by the simulated vehicle following the (routing option 1) as compared to being transported one-group-by-one-group without carpool; and the total extra passenger travel time for the (routing option 2) is a summation of extra time costing the passenger groups P and Q when transported by the simulated vehicle following the (routing option 2) as compared to being transported one-group-by-one-group without carpool.

In some embodiments, the method for providing vehicle navigation simulation environment may further comprise: if the total extra passenger travel time for the (routing option 1) is less than the total extra passenger travel time for the (routing option 2), assigning the simulated vehicle to follow the (routing option 1); and if the total extra passenger travel time for the (routing option 1) is more than the total extra passenger travel time for the (routing option 2), assigning the simulated vehicle to follow the (routing option 2).

As such, the disclosed environment can be used to train models and/or algorithms for vehicle navigation. Existing technologies have not developed such systems and methods that can provide a robust mechanism for training policies for vehicle services. The environment is a key for providing optimized policies that can guide vehicle driver effortlessly while maximizing their gain and minimizing passenger time cost. That is, the above-described recursive performance of the steps (1)-(4) based on historical data of trips taken by historical passenger groups can train a policy that maximizes a cumulative reward for the time period; and the trained policy determines an action for a real vehicle in a real environment when the real vehicle has no passenger, the action for the real vehicle in the real environment being selected from: (action 1) waiting at a current location of the real vehicle, and (action 2) determining the value M to transport M real passenger groups each comprising one or more passengers. For the real vehicle in the real environment, the (action 2) may further comprise: determining the M real passenger groups from available real passenger groups requesting vehicle service; if M is more than 1, determining an order for: picking up each of the M real passenger groups and dropping off each of the M passenger groups; and transporting the determined M real passenger groups according to the determined order. Therefore, the provided simulation environment paves the way for generating automatic vehicle guidance that makes passenger-picking or waiting decisions as well as carpool routing decisions for real vehicle drivers, which are unattainable by existing technologies.

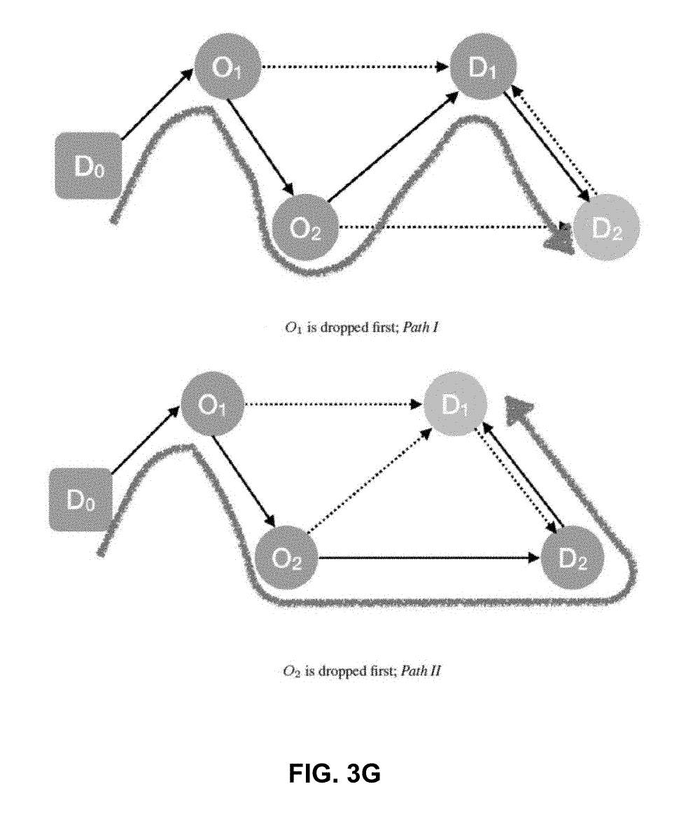

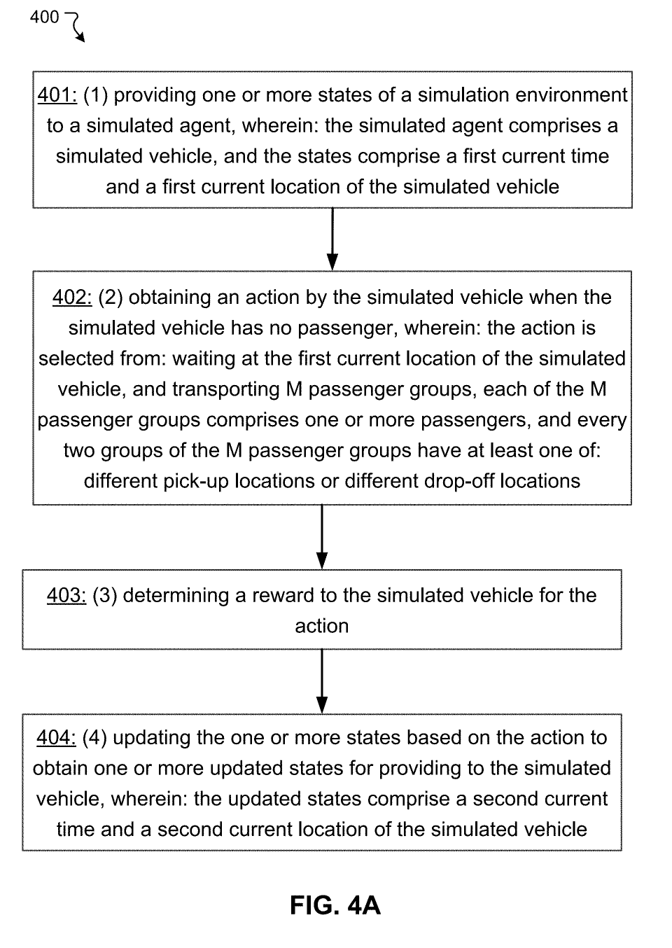

FIG. 4A illustrates a flowchart of an exemplary method 400 for providing vehicle navigation simulation environment, according to various embodiments of the present disclosure. The exemplary method 400 may be implemented in various environments including, for example, the environment 100 of FIG. 1. The exemplary method 400 may be implemented by one or more components of the system 102a (e.g., the processor 104a, the memory 106a). The exemplary method 400 may be implemented by multiple systems similar to the system 102a. The operations of method 400 presented below are intended to be illustrative. Depending on the implementation, the exemplary method 400 may include additional, fewer, or alternative steps performed in various orders or in parallel.

The exemplary method 400 may comprise recursively performing steps (1)-(4) for a time period (e.g., a day). At block 401, step (1) may comprise providing one or more states of a simulation environment to a simulated agent. The simulated agent comprises a simulated vehicle, and the states comprise a first current time and a first current location of the simulated vehicle. At block 402, step (2) may comprise obtaining an action by the simulated vehicle when the simulated vehicle has no passenger. The action is selected from: waiting at the first current location of the simulated vehicle, and transporting M passenger groups. Each of the M passenger groups comprises one or more passengers. Every two groups of the M passenger groups have at least one of: different pick-up locations or different drop-off locations. At block 403, step (3) may comprise determining a reward to the simulated vehicle for the action. At block 404, step (4) may comprise updating the one or more states based on the action to obtain one or more updated states for providing to the simulated vehicle. The updated states comprise a second current time and a second current location of the simulated vehicle.

In some embodiments, the exemplary method 400 may be executed to obtain a simulator/simulation environment for training an algorithm or a model as described above. For example, the training may intake historical trip data to obtain a policy that maximizes a cumulative reward over the time period. The historical data may include details of historical passenger trips such as historical time points and locations of pick-ups and drop-offs.

Accordingly, the trained policy can be implemented on various computing devices to help service vehicle drivers to maximize their reward when they work on the streets. For example, a service vehicle driver may install a software application on a mobile phone and use the application to access the vehicle platform to receive business. The trained policy can be implemented in the application to recommend the driver to take a reward-optimizing action. For example, when the vehicle has no passenger onboard, the trained policy as executed may provide a recommendation such as: (1) waiting at the current position, (2) picking up 1 passenger group, (3) picking up 2 passenger groups, (3) picking up 3 passenger groups, etc. Each passenger group includes one or more passengers. The passenger groups to be picked up have already requested the transportations from the vehicle platform, and their requested pick-up locations are known to the application. The details for determining the recommendation are described below with reference to FIG. 4B.

FIG. 4B illustrates a flowchart of an exemplary method 450 for providing vehicle navigation, according to various embodiments of the present disclosure. The exemplary method 450 may be implemented in various environments including, for example, the environment 200 of FIG. 2. The exemplary method 450 may be implemented by one or more components of the system 102b (e.g., the processor 104b, the memory 106b) or the computing device 110. For example, the method 450 may be executed by a server to provide instructions to the computing device 110 (e.g., a mobile phone used by a vehicle driver). The method 450 may be implemented by multiple systems similar to the system 102b. For another example, the method 450 may be executed by the computing device 110. The operations of method 450 presented below are intended to be illustrative. Depending on the implementation, the exemplary method 450 may include additional, fewer, or alternative steps performed in various orders or in parallel.

At block 451, a current number of real passengers onboard of a real vehicle may be determined. In one example, this step may be triggered when a vehicle driver activates a corresponding function from an application. In another example, this step may be performed constantly by the application. Since the vehicle driver relies on the application to interact with the vehicle platform, the application keeps track if current transportation tasks have been completed. If all tasks have been completed, the application can determine that no passenger is onboard. At block 452, in response to determining no real passenger onboard of the real vehicle, providing an instruction to transport M real passenger groups, based at least on a trained policy that maximizes a cumulative reward for the real vehicle. The training of the policy is described above with reference to FIG. 1, FIGS. 3A-3G, and FIG. 4A. Each of the M passenger groups may comprise one or more passengers. Every two groups of the M passenger groups may have at least one of: different pick-up locations or different drop-off locations. The real vehicle is at a first current location. For M=0, the instruction may comprise waiting at the first current location. For M=1, the instruction may comprise transporting passenger group R. For M=2, the instruction may comprise transporting passenger groups R and S in carpool. The passenger group R's pick-up location may take the least time to reach from the first current location. Transporting the passenger groups R and S in carpool may be associated with a least sum value of: a total extra passenger travel time for (routing option 1) and a total extra passenger travel time for (routing option 2). The (routing option 1) may comprise picking up the passenger group S, then dropping of the passenger group R, and then dropping of the passenger group S. The (routing option 2) may comprise picking up the passenger group S, then dropping of the passenger group S, and then dropping of the passenger group R. The total extra passenger travel time for the (routing option 1) may be a summation of extra time costing the passenger groups R and S when transported by the real vehicle following the (routing option 1) as compared to being transported group-by-group without carpool. The total extra passenger travel time for the (routing option 2) may be a summation of extra time costing the passenger groups R and S when transported by the real vehicle following the (routing option 2) as compared to being transported group-by-group without carpool.

In some embodiments, if the total extra passenger travel time for the (routing option 1) is less than the total extra passenger travel time for the (routing option 2), the instruction may comprise following the (routing option 1). If the total extra passenger travel time for the (routing option 1) is more than the total extra passenger travel time for the (routing option 2), the instruction may comprise following the (routing option 2).

In some embodiments, the trained policy can determine the M for providing the instruction when the vehicle has no passenger. Having determined M=1, the trained policy may automatically determine the passenger group R from current users requesting vehicle service. Having determined M=2, the trained policy may automatically determine the passenger groups R and S from current users requesting vehicle service, and determine the optimized routing option as described above. Similarly, the trained policy may determine passenger groups and routing options for M=3, M=4, etc. For each of the determination, the trained policy may maximize the reward to the vehicle driver, minimize the time cost to the passengers, maximize the efficiency of the vehicle platform, maximize the efficiency of the vehicle service, and/or optimize other parameters according to the training. Alternatively, the trained policy may determine the M, and the passenger group determination and/or the routing determination may be performed by algorithms (e.g., algorithms similar to Algorithms 2 to 4 and installed in a computing device or installed in a server coupled to the computing device).

In some embodiments, the trained policy to maximize the cumulative reward may employ a deep reinforced learning method (Deep Q-Networks (DQN), where function approximation techniques are used over a tabular Q-learning. The simplest method to obtain a policy would be tabular Q-learning where the algorithm keeps a record of the value functions in a tabular form. However, when the state and/or action space is large, maintaining such a big table is expensive. For this reason, in some embodiments, function approximation techniques are used which approximately learn this table. For example, in DQN, deep neural networks are used to approximate either the Q function or the value function. Deep reinforced learning (Deep RL) has become popular because of its success in gaming technologies where the state space has hundreds of features. In contrast, in carpooling, the state space is much larger, as the state is composed of latitude and longitude coordinates along with a continuous variable—time of the day. For that reason, in some embodiments, DQN is suitable in generating the optimal policy to maximize the cumulative reward of carpooling.

In some embodiments, in establishing the policy, it is assumed that a vehicle (e.g. taxi) is completely relying on RL in order to decide on carpool by learning the value function of a vehicle's state-action pair from the gathered experience generated from the carpooling simulator. Specifically, a model-free RL approach is adopted to learn an optimal policy as an agent (e.g., vehicle) does not know anything about the state transitions and rewards distributions. A policy π, includes, in one embodiment, a mapping function, which models the agent's action selection given a state where the value of a policy is determined by the state-action value function Vπ(s)=E[R|s, π]. Here, R denotes the sum of discounted reward. The value function estimates how good for an agent to be in a given state and an optimal policy is associated with the maximum possible value of Vπ(s). Given an optimal policy and an action in a given state s, the action-value under an optimal policy is defined by Q(s, a)=E[R|s, a, π].

In some embodiments, with temporal difference Q-learning (Tabular-Q), the Q-value function Q(s, a) is estimated by updating a lookup table for determining the Q-value function as Q(sₜ, a):=Q(sₜ, a)+α[r+γ maxₐ Q(sₜ₊₁, a)−Q(sₜ, a)]. Here, 0≤γ<1 is a discount rate, modeling the behavior of the agent when to prefer long term reward (γ→1) than immediate reward (γ=0) and 0<α≤1 is the step size parameter which controls the learning rate. In training, the epsilon-greedy policy is employed, where with probability 1−∈, an agent in state s selects an action a having the highest value Q(s, a) (exportation), and with probability ∈, the agent chooses a random action to ensure exploration.

In a case, tabular Q-learning is good for small MPD problems. However, with the huge state-action space or when the state space is continuous, a function approximator to model the Q(s, a)=fθ (s, a) would be useful. The best example of function approximator is neural networks (Universal function approximator). A basic neural network architecture would be useful for large MPD problems, where the neural network takes the state space (longitude, latitude, time of day) as inputs and output multiple Q values corresponding to the actions (W,TK1,TK2). To approximate the Q function, it may be useful to employ a three-layer deep neural network which learns the state-action value function. In some embodiments, the state transitions (experiences) are stored in a replay memory and each iteration samples a mini-batch from this replay memory. In the DQN framework, the mini-batch update through back-propagation is essentially a step for solving a bootstrapped regression problem with the loss function (Q(Sₜ, a|θ)−r(sₜ, a)−γ maxₐ Q(Sₜ₊₁, a|θ′))², where θ′ is the parameters for the Q-network of the previous iteration.

In some embodiments, the max operator is used both for selecting and evaluating an action which makes the Q-network training unstable. To improve the training stability, in some embodiments, Double-DQN may be employed, where a target Q-network \hat{Q}, is maintained and synchronized periodically with the original Q-network. Thus, the modified loss function is defined as: r (sₜ, a)+γ \hat{Q} (Sₜ+1, arg maxₐ Q(sₜ+1, a|θ′)\hat{θ}′). In some embodiments, the discount factor γ is preferably set to 0.95 to maximize per day revenue of the vehicle.

Accordingly, the vehicle driver can rely on policy and/or algorithm determinations to perform the vehicle service in an efficient manner, with maximization of her gain and/or minimization of passengers' time costs. The vehicle service may involve single passenger/passenger group trip and/or multi passenger/passenger group carpooling trips. The optimization result achieved by the disclosed systems and methods are not attainable by existing systems and methods. Currently, a vehicle driver even if provided with a location map of current vehicle services requests would not be able to determine the best move that brings more reward than other choices. The existing systems and methods cannot weigh between waiting and picking up passengers, cannot determine which passenger to pick up, and cannot determine the best route for carpooling trips. Therefore, the disclosed systems and methods at least mitigate or overcome such challenges in providing vehicle service and providing navigation.

Experimental Simulation:

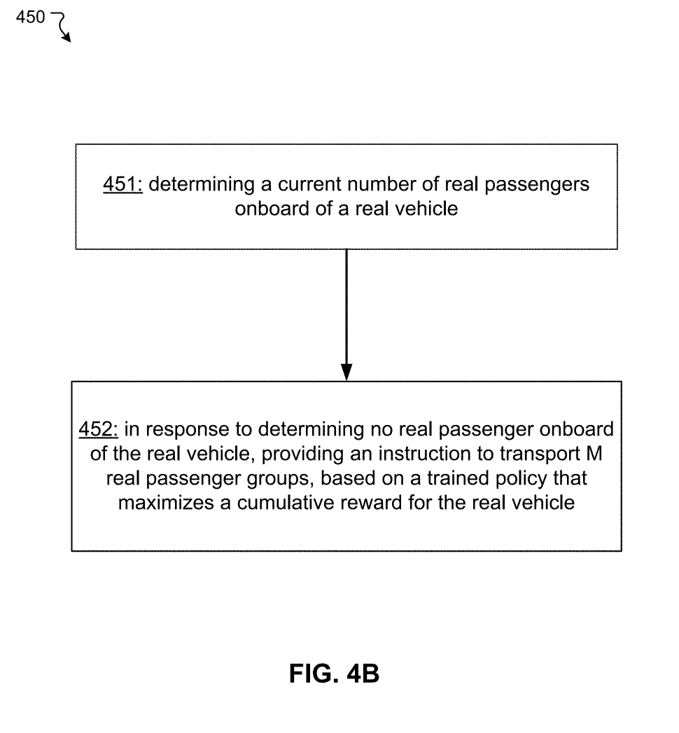

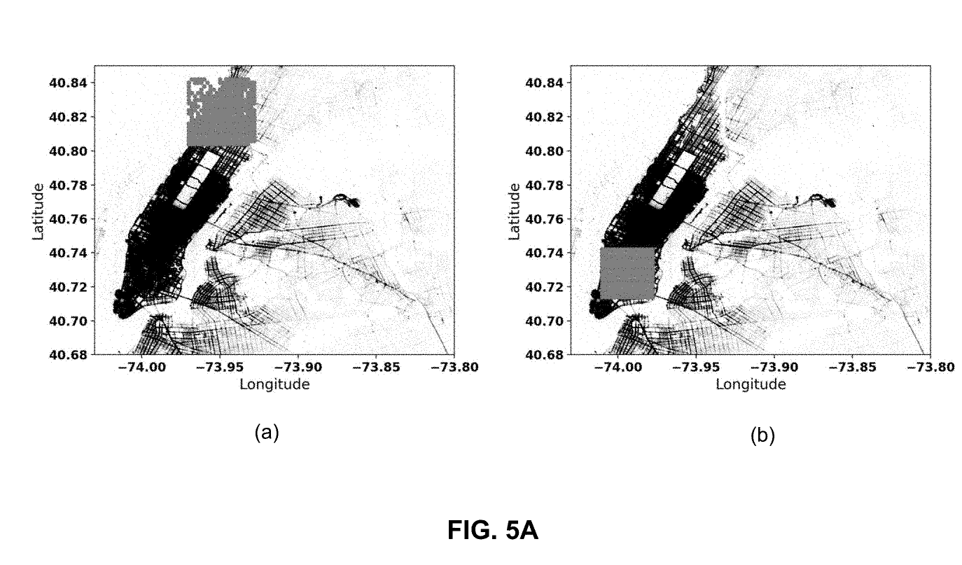

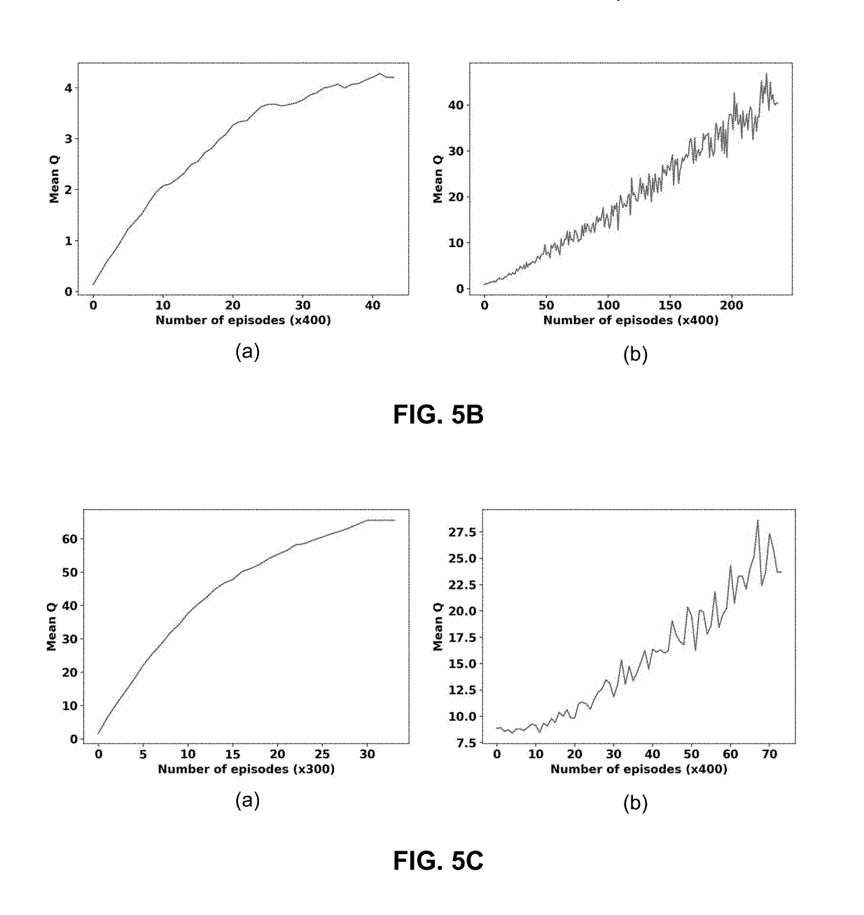

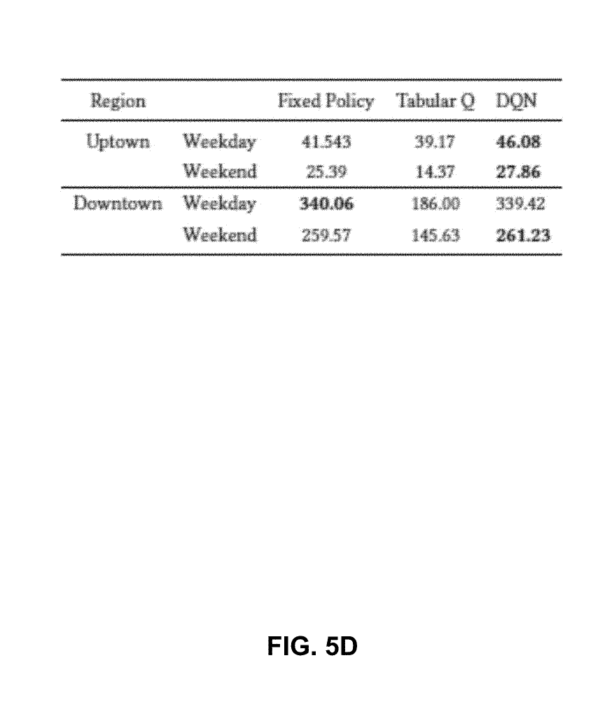

In the following, an experiment to analyze configured carpooling policies were discussed with reference to FIGS. 5A-5C. In the experiment, various carpooling policies including a DQN policy and a Tabular Q policy were examined in different geographical environments to analyze an optimal carpooling policy for the different geographical environments. An example of the experiment is discussed in the following reference incorporated herein by reference in its entirety: I. Jindal, Tony, Qin, X. Chen, M. Nokleby, and J. Ye., Deep Reinforcement Learning for Optimizing Carpooling Policies, October 2017. In the experiment, a single agent carpooling policy search was assumed where the decision taken by an agent (e.g., taxi) is independent of the other agents. In a single agent or multi-agent RL learning framework, an agent is a ride-sharing platform which takes decision for the taxis. In this experiment, it was assumed that ride-sharing platform takes decision for only a single taxi then taxi itself acts as an agent. For learning a tabular-Q policy, the selected geographical region was discretized into square cells of 0.0002 degree latitude×0.0002 degree longitude (about 200 meter×200 meter) forming a 2-D grid and also discretized the time of day with 600 s as sampling period, whereas for learning a DQN policy any of the variable was discretized.

In this experiment, the performance of different carpooling policies was evaluated both on weekday and weekend by comparing the mean cumulative reward with respect to the fixed policy (baseline), where a carpool is always accepted, and the tabular-Q policy. In the experiment, the samples of experience were generated in real-time from the carpooling simulator described above with reference to FIGS. 3B-3G.

In the experiment, the performance of different carpooling policies were examined for two different taxi call densities regions in Manhattan, Uptown Manhattan and Downtown Manhattan as illustrated in (a) and (b) of FIG. 5A, respectively. Specifically, for Uptown Manhattan, a square region in northern Manhattan in longitude [−73.9694, −73.9274] and in latitude [40.805, 40.8438] was selected as shown in (a) of FIG. 5A. For Downtown Manhattan, a square region of Downtown Manhattan in longitude [−74.0094, −73.9774] and in latitude [40.715, 40.7438] was selected as shown in (b) of FIG. 5A.

FIG. 5B illustrates a Q-value deviation of DQN policy and Tabular Q policy in the region of Uptown Manhattan with respect to the fixed policy as a baseline in (a) and (b), respectively. Specifically, in FIG. 5B, action-values (Q-value) averaged over mini-batches were plotted for the DQN policy in (a) of FIG. 5B, and for the Tabular Q, Q-value was averaged over a number of episodes in (b) of FIG. 5B for a weekday. FIG. 5C illustrates a Q-value deviation of DQN policy and Tabular Q policy in the region of Downtown Manhattan with respect to the fixed policy as a baseline in (a) and (b), respectively. Similarly to FIG. 5B, the action-values were plotted for the DQN policy and the Tabular Q policy on a weekday in (a) and (b), respectively. In both policies and both regions, it was found that mean Q smoothly converged after few thousand episodes, when the training of RL network was stopped.

FIG. 5D illustrates a table showing mean cumulative rewards on weekday and weekend on both of the Uptown and Downtown regions. As shown, on weekday the DQN policy and the fixed policy performed equally well. This result is obtained because the downtown Manhattan region is highly dense taxi calls area and it is always good to do carpool. On the other hand, during a weekend taxi calls density was reduced and the DQN policy learned an optimal policy better than the baseline policy.

The tabular-Q policy's performance was always worst because the state-action space is huge and obtaining Q value for such a state-action space is not practical. In all the experiment policies, a very sparse Q value table was obtained. At test time there were some states where Q values for all the actions are equal that is zero.

In downtown Manhattan where the taxi calls are very frequent, DQN policy always favored for carpool and generated the reward similar to the fixed policy. On the other hand, in uptown Manhattan where taxi calls are less frequent, the DQN policy caused the taxi to get into higher-value regions by taking TK1 or W action. To get a better understanding of the earned revenue, a location l in uptown Manhattan was randomly selected and a full episode was run to generate the sequence of actions and rewards both for the fixed policy and for the DQN policy. During morning hours the DQN policy and the fixed policy followed the same set of action sequence but later in time, the DQN policy started compromising immediate rewards, in turn, to get more long-term cumulative reward by causing the taxi to move towards the high action-value regions.

### Optimal Policy Matching:

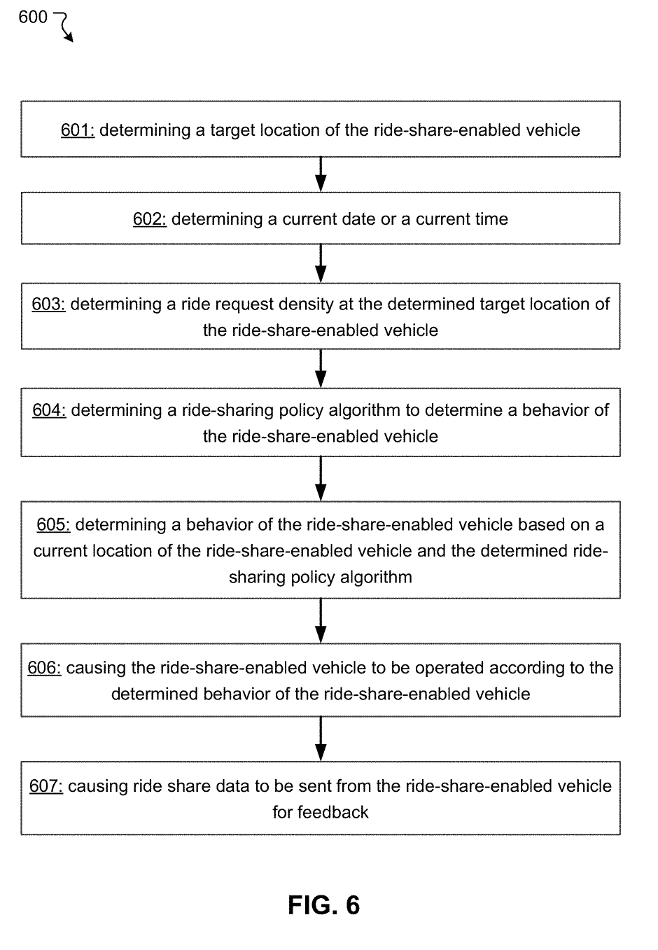

FIG. 6 illustrates a flowchart 600 of an exemplary method for operation of a ride-share-enabled vehicle according to various embodiments. This flowchart illustrates blocks (and potentially decision points) organized in a fashion that is conducive to understanding. It should be recognized, however, that the blocks can be reorganized for parallel execution, reordered, modified (changed, removed, or augmented), where circumstances permit. In the example of FIG. 6, the blocks of the flowchart 600 are performed by an applicable device located outside of a ride-share-enabled vehicle, e.g., a server, by an applicable device located inside of the ride-share-enabled vehicle, e.g., a mobile device carried by a driver or a computing device embedded or connected to the ride-share-enabled vehicle, or by a combination thereof.

In the example of FIG. 6, the flowchart 600 starts at block 601, with determining a target location of the ride-share-enabled vehicle. In some embodiments, the target location of the ride-share-enabled vehicle may be a target service region for a ride share service. For example, a target service region may be an applicable geographical region, such as New York metro area, downtown New York City, Uptown Manhattan, and so on. In some embodiments, the target location of the ride-share-enabled vehicle may be a current location of the ride-share-enabled vehicle. For example, the current location of the ride-share-enabled vehicle may be expressed by GPS information.

In the example of FIG. 6, the flowchart 600 continues to block 602, with determining a current date or a current time. In some embodiments, the current date may be expressed by day in week (e.g., Sunday, Monday, etc.), weekday or weekends, day and month (e.g., July 12), and so on. In some embodiments, a current time may be expressed by time frame in day (e.g., morning, afternoon, evening, etc.), time range in day (e.g., 0-6 AM, 6-12 AM, 0-6 PM, and 6-12 PM, etc.), and so on.

In the example of FIG. 6, the flowchart 600 continues to block 603, with determining a ride request density at the determined target location of the ride-share-enabled vehicle. In some embodiments, an actual ride request density obtained from statistic ride sharing data may be determined as the ride request density. In some embodiments, estimated ride request density is determined as the ride request density. In a specific implementation, an estimated ride request density may be determined based on demographic information (e.g., population density) and/or the current date or the current time. For example, a ride request density in a higher population density area at day time may be estimated to be higher than a ride request density in a lower population density area at night time. In some embodiments, when the target location of the ride-share-enabled vehicle is a current location thereof, the actual ride request density and/or the estimated ride request density may be calculated as an average in a small region (e.g., 200 m×200 m square region) including the current location.

In the example of FIG. 6, the flowchart 600 continues to block 604, with determining a ride-sharing policy algorithm to determine a behavior of the ride-share-enabled vehicle. In some embodiments, potential ride-sharing policy algorithms to be selected may include one or more of a DQN policy algorithm, a Tabular-Q policy algorithm, and a fixed policy algorithm. In some embodiments, the ride-sharing policy algorithm is configured to determine a behavior of the ride-share-enabled vehicle including whether to accept a multiple shared ride or maintain a single shared ride and a route of the multiple shared ride, if any, so as to increase (e.g., maximize) revenue from driving of the ride-share-enabled vehicle while reducing (e.g., minimizing) passenger ride time. In some embodiments, use of computing resources or power consumption to execute a ride-sharing policy algorithm may be also taken into consideration, especially when the ride-sharing policy algorithm is executed by a computing device in the ride-share-enabled vehicle. In a situation, a fixed policy algorithm may require less computing resources, thereby less power consumption compared to the DQN policy algorithm, because multiple ride share is always accepted. In some embodiments, the ride-sharing policy algorithm is determined based on one or more of the determined target location of the ride-share-enabled vehicle (block 601), the determined current date or current time (block 602), and the determined ride request density (block 603).

In a specific implementation, when the target location is a first location, a first ride-sharing policy algorithm is determined as the ride-sharing policy algorithm; and when the target location is a second location different from the first location a second ride-sharing policy algorithm different from the first ride-sharing policy algorithm is determined as the ride-sharing policy algorithm. For example, when the first location is more populated than the second location, the first ride-sharing policy algorithm is configured to accept more multiple shared rides than the second ride-sharing policy algorithm. In such a situation, for example, the first ride-sharing policy algorithm is a fixed policy algorithm, and the second ride-sharing policy algorithm is a DQN policy algorithm.

In a specific implementation, when the ride request density is a first density, a first ride-sharing policy algorithm is determined as the ride-sharing policy algorithm; and when the ride request density is a second density less dense than the first location, a second ride-sharing policy algorithm different from the first ride-sharing policy algorithm is determined as the ride-sharing policy algorithm. The first ride-sharing policy algorithm is configured to accept more multiple shared rides than the second ride-sharing policy algorithm. In such a situation, for example, the first ride-sharing policy algorithm is a fixed policy algorithm, and the second ride-sharing policy algorithm is a DQN policy algorithm.

In the example of FIG. 6, the flowchart 600 continues to block 605, with determining a behavior of the ride-share-enabled vehicle based on a current location of the ride-share-enabled vehicle and the determined ride-sharing policy algorithm. In some embodiments, a behavior of the ride-share-enabled vehicle may including waiting, transporting one passenger group, two passenger groups (e.g., accepting second passenger group), three passenger groups (e.g., accepting third passenger group), etc.

In the example of FIG. 6, the flowchart 600 continues to block 606, with causing the ride-share-enabled vehicle to be operated according to the determined behavior of the ride-share-enabled vehicle. In some embodiments, an instruction to operate the ride-share-enabled vehicle is transmitted from a server outside the ride-share-enabled vehicle to a mobile device carried by a human driver of the ride-share-enabled vehicle, such that the human driver drives according to the instruction. In some embodiments, an instruction to operate the ride-share-enabled vehicle is transmitted from a server outside the ride-share-enabled vehicle to a computing device embedded in or connected to the ride-share-enabled vehicle, such that an artificial agent performs autonomous driving according to the instruction. In some embodiments, an instruction to operate the ride-share-enabled vehicle is generated within the ride-share-enabled vehicle based on execution of a determined ride-sharing policy algorithm therein, and the generated instruction is provided (e.g., displayed) to a human driver or an artificial agent.

In the example of FIG. 6, the flowchart 600 continues to block 607, with causing ride share data to be sent from the ride-share-enabled vehicle for feedback. In some embodiments, ride share data includes pieces of heartbeat information such as a geographical location, vehicle state (e.g., wait, take1, take 2, etc.) and time. In some embodiments, ride share data may include information variable containing Pick up latitude, Pick up longitude. Pick up time, Drop off latitude, Drop off longitude, Drop off time, Travel time, Travel distance. In some embodiments, ride share data are sent to a server for feedback, at which ride-sharing policy algorithms are updated based on the ride share data according to reinforced machine learning.

### Hardware Architecture:

The techniques described herein are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques. Computing device(s) are generally controlled and coordinated by operating system software. Conventional operating systems control and schedule computer processes for execution, perform memory management, provide file system, networking, I/O services, and provide a user interface functionality, such as a graphical user interface (“GUI”), among other things.

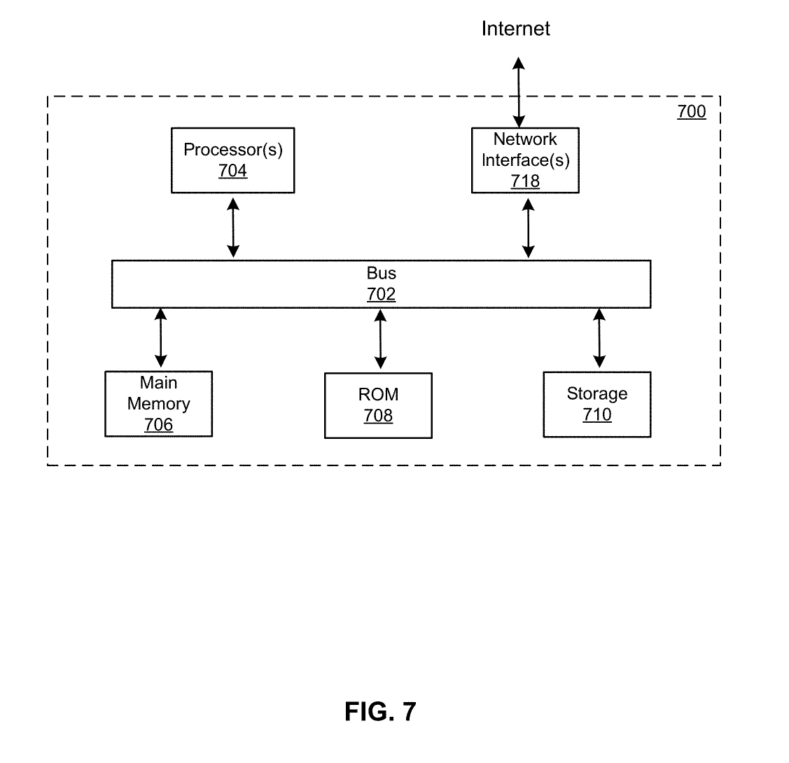

FIG. 7 is a block diagram that illustrates a computer system 700 upon which any applicable embodiments described herein may be implemented. In some embodiments, the system 700 may correspond to the system 102a or 102b described above. In some embodiments, the system 700 may correspond to the computing devices 109a, 109b, 110, and/or 111. The computer system 700 includes a bus 702 or other communication mechanism for communicating information, one or more hardware processors 704 coupled with bus 702 for processing information. Hardware processor(s) 704 may be, for example, one or more general purpose microprocessors. The processor(s) 704 may correspond to the processor 104a or 104b described above.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions. The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions. The main memory 706, the ROM 708, and/or the storage 710 may correspond to the memory 106a or 106b described above.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

The main memory 706, the ROM 708, and/or the storage 710 may include non-transitory storage media. The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The computer system 700 also includes a communication interface 718 coupled to bus 702. Communication interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN (or WAN component to communicated with a WAN). Wireless links may also be implemented. In any such implementation, communication interface 718 sends and receives electrical, electromagnetic or optical signals that carry digital data streams representing various types of information.

The computer system 700 can send messages and receive data, including program code, through the network(s), network link and communication interface 718. In the Internet example, a server might transmit a requested code for an application program through the Internet, the ISP, the local network and the communication interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The Detailed Description is not to be taken in a limiting sense, and the scope of various embodiments is defined only by the appended claims, along with the full range of equivalents to which such claims are entitled.

1. A method for operating a ride-share-enabled vehicle comprising:
determining a target location of the ride-share-enabled vehicle;
determining a ride-sharing policy algorithm to determine a behavior of the ride-share-enabled vehicle including whether to accept a multiple shared ride or maintain a single shared ride and a route of the multiple shared ride, based on the determined target location of the ride-share-enabled vehicle;
determining a behavior of the ride-share-enabled vehicle based on a current location of the ride-share-enabled vehicle and the determined ride-sharing policy algorithm; and
causing the ride-share-enabled vehicle to be operated according to the determined behavior of the ride-share-enabled vehicle.

2. The method of claim 1, wherein the determined ride-sharing policy algorithm is configured based on a deep reinforced learning method of a deep Q-Networks (DQN).

3. The method of claim 1, further comprising determining a current date or a current time, wherein the ride-sharing policy algorithm is determined also based on the current date or the current time.

4. The method of claim 1, wherein the determining the ride-sharing policy algorithm comprises:
determining a first ride-sharing policy algorithm as the ride-sharing policy algorithm, when the target location is a first location; and
determining a second ride-sharing policy algorithm different from the first ride-sharing policy algorithm as the ride-sharing policy algorithm, when the target location is a second location different from the first location.

5. The method of claim 4, wherein the first location is more populated than the second location, and the first ride-sharing policy algorithm is configured to accept more multiple shared rides than the second ride-sharing policy algorithm.

6. The method of claim 5, wherein the first ride-sharing policy algorithm is not configured based on a deep reinforced learning method of a deep Q-Networks (DQN), and the second ride-sharing policy algorithm is configured based on the deep reinforced learning method of the DQN.

7. The method of claim 1, further comprising determining a ride request density at the determined target location of the ride-share-enabled vehicle, wherein the ride-sharing policy algorithm is determined based on the determined ride request density.

8. The method of claim 7, further comprising determining a current date or a current time, wherein the ride request density at the determined target location of the ride-share-enabled vehicle is determined based on the current date or the current time.

9. The method of claim 7, wherein the determining the ride-sharing policy algorithm comprises:
determining a first ride-sharing policy algorithm as the ride-sharing policy algorithm, when the ride request density is a first density; and
determining a second ride-sharing policy algorithm different from the first ride-sharing policy algorithm as the ride-sharing policy algorithm, when the ride request density is a second density less dense than the first location.

10. The method of claim 9, wherein the first ride-sharing policy algorithm is configured to accept more multiple shared rides than the second ride-sharing policy algorithm.

11. The method of claim 10, wherein the first ride-sharing policy algorithm is not configured based on a deep reinforced learning method of a deep Q-Networks (DQN), and the second ride-sharing policy algorithm is configured based on the deep reinforced learning method of the DQN.

12. The method of claim 1, wherein the target location of the ride-share-enabled vehicle comprises a target service region for a ride share service.

13. The method of claim 1, wherein the target location of the ride-share-enabled vehicle comprises the current location of the ride-share-enabled vehicle.

14. A non-transitory computer-readable storage medium storing instructions that, when executed by one or more processors, cause the one or more processors to perform a method for operating a ride-share-enabled vehicle, the method comprising:
determining a target location of the ride-share-enabled vehicle;
determining a ride-sharing policy algorithm to determine a behavior of the ride-share-enabled vehicle including whether to accept a multiple shared ride or maintain a single shared ride and a route of the multiple shared ride, based on the determined target location of the ride-share-enabled vehicle;
determining a behavior of the ride-share-enabled vehicle based on a current location of the ride-share-enabled vehicle and the determined ride-sharing policy algorithm; and
causing the ride-share-enabled vehicle to be operated according to the determined behavior of the ride-share-enabled vehicle.

15. The non-transitory computer-readable storage medium of claim 14, wherein the determined ride-sharing policy algorithm is configured based on a deep reinforced learning method of a deep Q-Networks (DQN).

16. The non-transitory computer-readable storage medium of claim 14, wherein the method further comprises determining a current date or a current time, wherein the ride-sharing policy algorithm is determined also based on the current date or the current time.

17. The non-transitory computer-readable storage medium of claim 14, wherein the method further comprises determining a ride request density at the determined target location of the ride-share-enabled vehicle, wherein the ride-sharing policy algorithm is determined based on the determined ride request density.

18. A system for providing a ride-share service comprising:
a server including one or more processors and memory storing instructions that, when executed by one or more processors, cause the one or more processors to perform a method for operating one or more ride-share-enabled vehicles, wherein the method comprises:
determining a target location of a target vehicle of the one or more ride-share-enabled vehicles;
determining a ride-sharing policy algorithm to determine a behavior of the target vehicle including whether to accept a multiple shared ride or maintain a single shared ride and a route of the multiple shared ride, if any, based on the determined target location of the target vehicle;
determining a behavior of the target vehicle based on a current location of the target vehicle and the determined ride-sharing policy algorithm; and
causing the target vehicle to be operated according to the determined behavior of the target vehicle.

19. The system of claim 18, wherein at least one of the one or more ride-share-enabled vehicles is an autonomous vehicle.

20. The system of claim 18, wherein the determined ride-sharing policy algorithm is configured based on a deep reinforced learning method of a deep Q-Networks (DQN).
